(19) United States
(12) Patent Application Publication
(10) Pub. No.: US 2002/0096888 A1
(43) Pub. Date: Jul. 25, 2002

(54) Interconnected lock with thumbturn rack connection

(76) Inventors: Peter K. Bates, Framingham, MA (US); Brian David Blankenship, Colorado Springs, CO (US); John Bussiere, Littleton, MA (US)

Correspondence Address: MICHAEL BEST & FRIEDRICH LLP, 3773 CORPORATE PARKWAY, SUITE 360, CENTER VALLEY, PA, 18034-8217, US

(21) Appl. No.: 09/765,795

(22) Filed: Jan. 19, 2001

(51) Int. Cl. E05C 1/12

(52) U.S. Cl. 292/172

(57) ABSTRACT

An interconnected lock assembly for mounting in a door, comprising a first lock assembly and a second lock assembly interconnected by a rack mounted on a carrier component. The second lock assembly is operably connected to a deadbolt latch assembly comprising a deadbolt moveable between an extended position when the carrier component is in a lowered position and a retracted position when the carrier component is in a raised position. The lock further comprises a thumbturn attached to a thumbturn link component, wherein the thumbturn link pivotally connects the thumbturn to the rack such that the thumbturn is operably interconnected to the first lock assembly and the second lock assembly.

### TECHNICAL FIELD

This invention relates generally to interconnected lock assemblies used to secure doors. More particularly, the present invention relates to an interconnected lock assembly which provides a unique thumbturn connection to a rack of an interconnected lock.

### BACKGROUND OF THE INVENTION

An interconnected lock assembly is characterized by an inside handle, either knob or lever, which simultaneously retracts both a deadlatch and a deadbolt. Such a lock assembly is commonly found in public accommodations such as hotels and motels in which, for security purposes, the occupant wishes to set both a deadlatch and a deadbolt. The same type of lock assembly may also be found in a residential or other environments. It is particularly important that both locks be retracted by the turning of a single inside operating member as it has been found that in the event of a fire or other panic situation it is desirable that the occupant only need turn a single knob or lever to operate all of the lock mechanisms in a particular door.

Such interconnected lock assemblies have been on the market for a number of years. Some interconnected lock assemblies are adjustable to compensate for varying distances between the latch assemblies. The adjustable feature is particularly helpful if there is a slight misalignment of the latch assembly bores, or when retrofitting an existing door if the distance between bore centerlines is not the same as the distance between the latch assemblies of the interconnected lock. One prior art design discloses an adjustable interconnected lock which enables interconnection of an exterior assembly that has an adjustable spacing between the exterior dead bolt assembly and a lower lock assembly.

One problem with interconnected lock assemblies is that the distance between the thumbturn and the lower lock assembly is a fixed distance while the distance between the exterior dead bolt assembly and the lower lock assembly is variable depending on the door. In order to mate the thumbturn to an interconnecting rack, an additional pinion is typically used often requiring a rack with teeth on both sides of a rack carrier. The thumbturn pinion adds additional parts to the assembly which may be susceptible to wear and breakage, potentially limiting the life of the lock assembly. The proper rotational positioning of the thumbturn is also difficult as the thumbturn is free to rotate until the pinion engages the rack.

The foregoing illustrates limitations known to exist in present interconnected lock assembly designs. Thus, it is apparent that it would be advantageous to provide an alternative directed to overcoming one or more of the limitations set forth above. Accordingly, a suitable alternative is provided including features more fully disclosed hereinafter.

### SUMMARY OF THE INVENTION

It is therefore an object of the present invention to provide an interconnected lock assembly with a unique thumbturn connection to a rack of an interconnected lock which is simple, easily installed, and relatively inexpensive. This and other objects of the present invention are provided by an interconnected lock assembly for mounting in a door, comprising a first lock assembly and a second lock assembly interconnected by a rack mounted on a carrier component. The second lock assembly is operably connected to a deadbolt latch assembly comprising a deadbolt movable between an extended position when the carrier component is in a lowered position and a retracted position when the carrier component is in a raised position. The lock further comprises a thumbturn attached to a thumbturn link component, wherein the thumbturn link pivotally connects the thumbturn to the rack such that the thumbturn is operably interconnected to said first lock assembly and said second lock assembly.

### BRIEF DESCRIPTION OF THE DRAWINGS

FIG. 1 is an exploded perspective view of the interconnected lock assembly of the present invention;

FIG. 2 is a perspective view of the assembled interconnected lock assembly in accordance with the present invention of FIG. 1;

FIG. 3 is a side elevational view of the assembled interconnected lock assembly, shown without the escutcheon assembly, in accordance with the present invention of FIG. 1;

FIG. 4A is an rearward perspective view of the escutcheon assembly, in accordance with the present invention of FIG. 1;

FIG. 4B is an frontal perspective view of the escutcheon assembly, in accordance with the present invention of FIG. 1;

FIG. 5 is a side elevational view of the assembled interconnected lock assembly, shown without the inside handle and with portions of the escutcheon and rack cut away to reveal interior portions, in accordance with the present invention of FIG. 1;

FIG. 6 is a side elevational view of the assembled interconnected lock assembly, shown without the inside handle and with portions of the escutcheon and rack cut away to reveal interior portions, in accordance with an alternate embodiment of the present invention;

FIG. 7 is a perspective view of the thumbturn link as shown in FIG. 4A; and

FIG. 8 is a perspective view of the thumbturn link of the alternate embodiment of the present invention as shown in FIG. 6.

### DETAILED DESCRIPTION

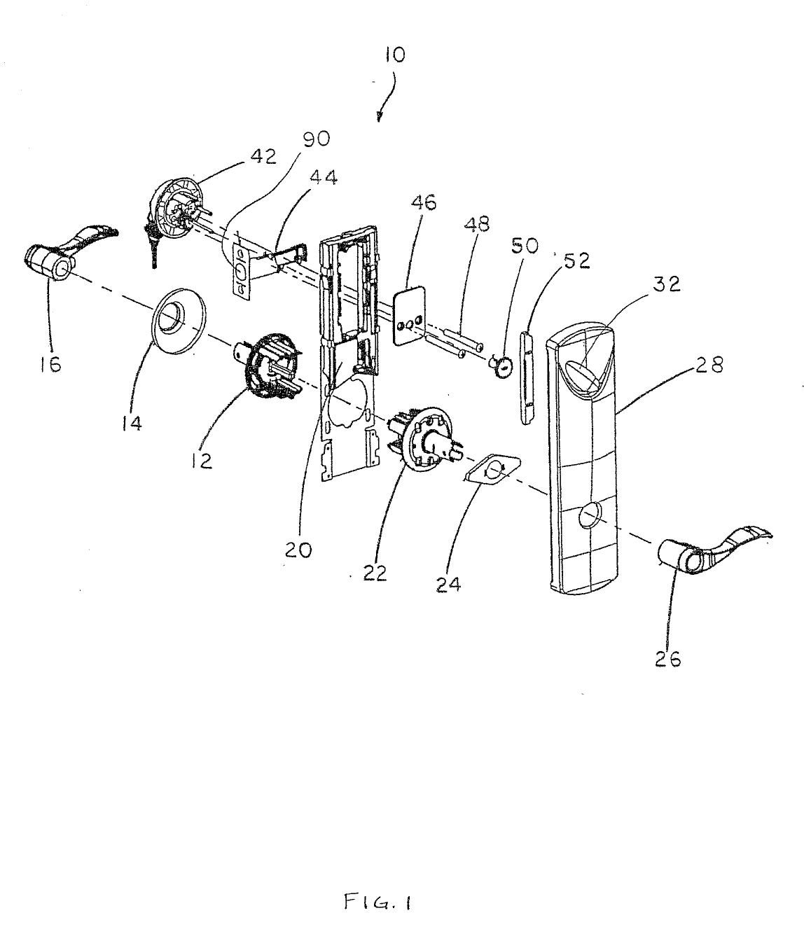

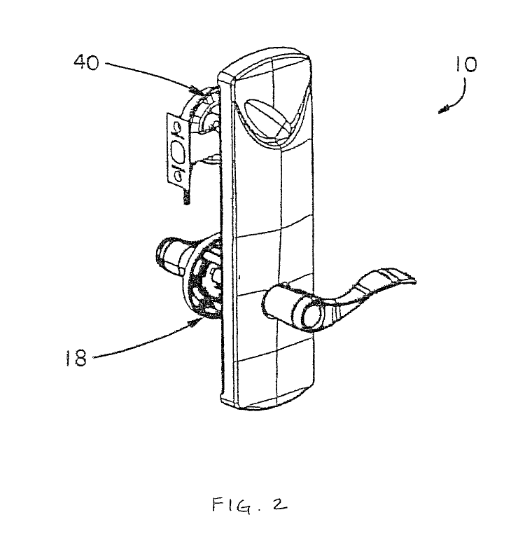

Referring now to the drawings, wherein similar reference characters designate corresponding parts throughout the several views, there is generally indicated at 10 an adjustable interconnected lock assembly of the present invention. Referring specifically to FIGS. 1 and 2, lock assembly 10 comprises a first or lower interconnected lock assembly 18 comprising outside housing assembly 12, rose 14, and outside knob/lever 16, attached from the outside of a door (not shown) through a first or lower bore in the door, and through a back plate assembly 20 positioned on the inside of the door, to inside housing assembly 22. Interconnect cam 24, escutcheon assembly 28, and inside knob/lever 26 are attached to inside housing assembly 22 on the inside of the door. Although not shown, a latch assembly could be operably connected between outside housing assembly 12 and inside housing assembly 22. Interconnected lock assembly 10 also comprises a second or upper interconnected lock assembly 40 comprising a deadbolt housing assembly 42 and a deadbolt latch assembly 44. Deadbolt housing assembly 42 is attached from the outside of the door through a second or upper bore and operably connected to deadbolt latch assembly 44, and through back plate assembly 20 and secured thereto by deadbolt plate 46 and mounting screws 48. Deadbolt housing assembly 42 is operably connected to a deadbolt pinion 50 which engages a deadbolt rack 52 connected to back plate assembly 20 as discussed in detail below. The lower interconnected lock 18 and upper interconnected lock 40 are standard configurations that are well-known in the art, and as such, the workings of these locks will not be described in detail, except as they relate to the present invention.

Referring now to FIG. 3, interconnected lock 10 shown with escutcheon assembly 28 removed. Back plate assembly 20 comprises a carrier component 54 vertically movable on, and slidably attached to a back plate 56 by a plurality of tangs 58. Deadbolt rack 52 is oriented vertically and fixedly attached to carrier component 54 such that it engages pinion 50. Interconnected lock 10 is adjustable in that upper lock assembly 40 can move up or down to properly fit the upper bore of the door. Deadbolt plate 46 is movable within a slot 62 in back plate 56 to allow the proper positioning of upper lock assembly 40. Upper lock assembly 40 is then secured to deadbolt plate 46 by mounting screws 48 which secure upper lock assembly 40 in a fixed position. Deadbolt assembly 42 is operably connected to deadbolt pinion 50 by a driver bar 60 which is co-rotatingly attached to deadbolt pinion 50. Carrier component 54 is shown in a raised, or unlock position. When carrier component 54 is in a lowered, or locked position, a mating cam surface 64 of carrier component 54 engages cam 24. Cam 24 is attached to knob/lever 26 in a co-rotating manner such that rotation of knob/lever 26 rotates cam 24 which engages mating cam surface 64, causing carrier component 54 to move vertically, upwardly to a raised, or unlock position. The rack 52 attached to carrier component 54 causes deadbolt pinion 50 to rotate as carrier component 54 moves either upward or downward. Driver bar 60 co-rotates with deadbolt pinion 50. Rotation of driver bar 60 causes retraction and extension of a deadbolt 90 of deadbolt latch assembly 44 in a standard fashion. Accordingly, as carrier component 54 moves upward, deadbolt 90 of deadbolt latch assembly 44 is retracted, allowing the door to be opened.

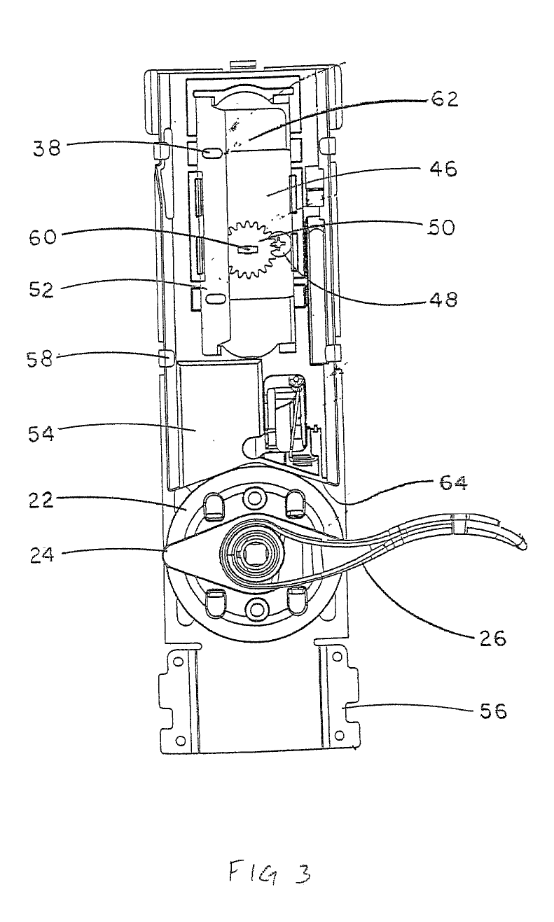

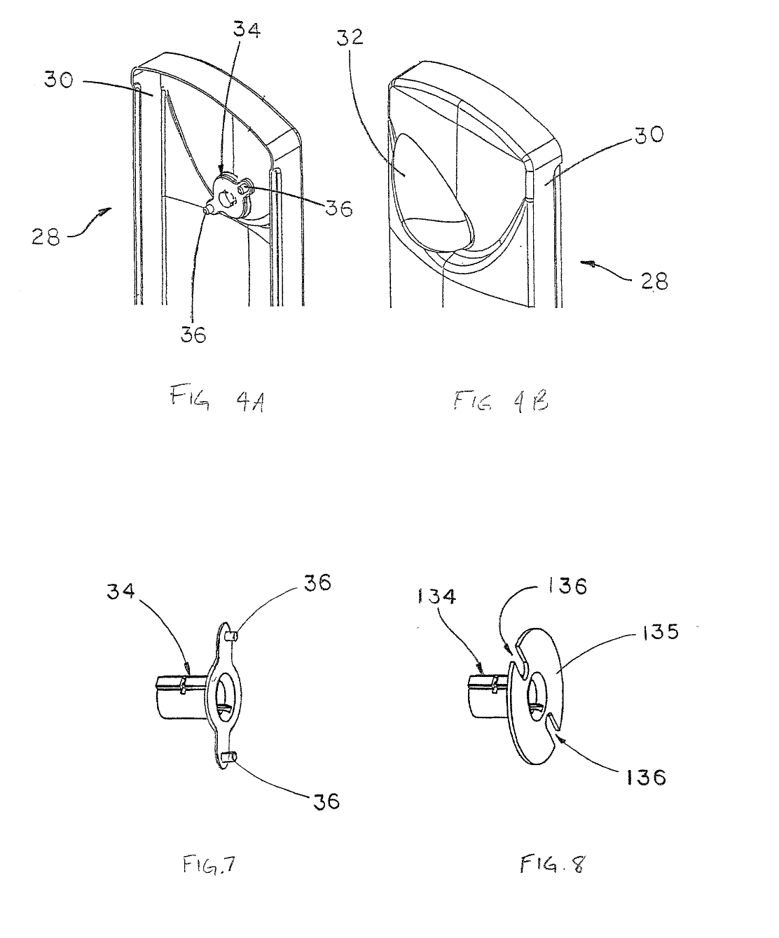

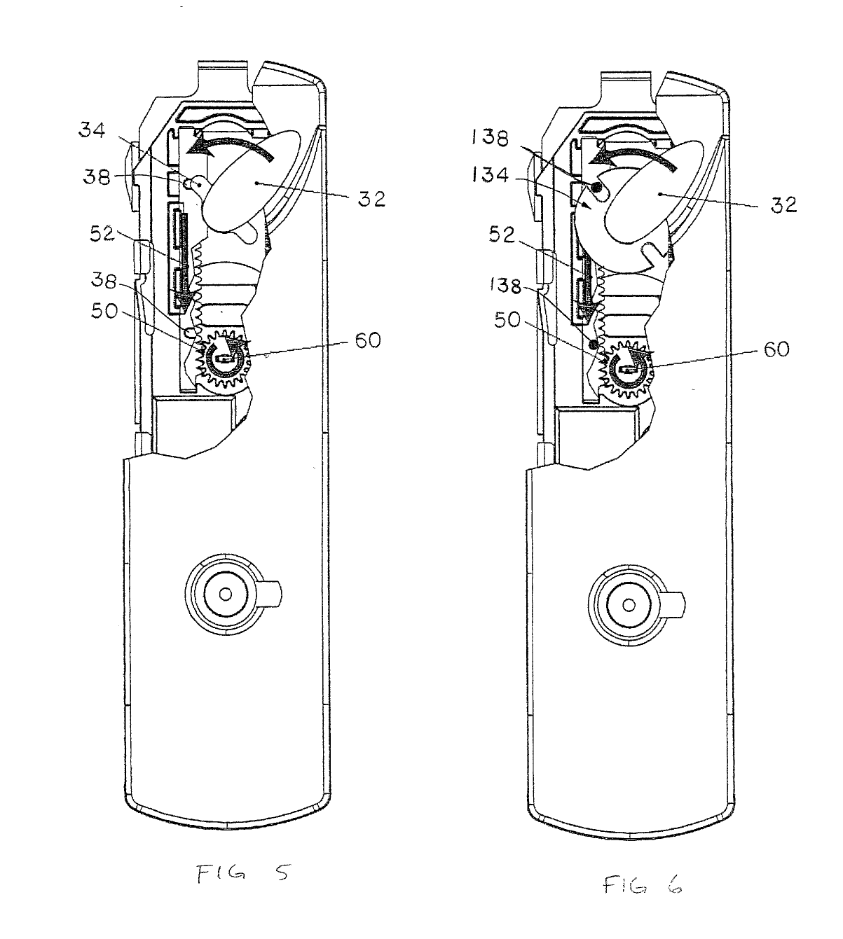

Referring now to FIGS. 4A and 4B, escutcheon assembly 28 comprises escutcheon 30, thumbturn 32, and thumbturn link component 34. Thumbturn is coupled to thumbturn link component 34 in a co-rotating manner through an aperture in escutcheon 30. Thumbturn link component 34 32, best shown in FIG. 7, comprises at least one pin 36 which engages an aperture 38 in rack 52, linking thumbturn 32 to carrier component 54. This engagement ensures that the thumbturn is properly positioned whereas in designs utilizing a pinion, trial and error must often be resorted to obtain the proper thumbturn rotational position. It is noted that rack 52 can be positioned on either side of carrier component 54 such that a pin 36 will engage an aperture 38 in rack 52, allowing thumbturn 32 to be appropriately attached for right and left-hand opening doors. Thumbturn link component 34 directly engages rack 52, not the teeth of rack 52 such as in the case with prior art designs utilizing a pinion. Movement of the carrier component 54 results in rotation of thumbturn 32, and conversely, rotation of thumbturn 32 causes movement of carrier component 54 through rack 52, and rack 52 causes rotation of pinion 50 as best shown in FIG. 5.

Another embodiment of the present invention is shown in FIG. 6. Thumbturn link 134 comprises a circular base portion 135 having at least one slot 136 cut radially inward from the perimeter of circular base portion 135 as best shown in FIG. 8. A rack 152 comprises at least one pin 138 extending generally perpendicularly from rack 152 and engaging slot 136 of thumbturn link 134. Rack 152 has a second pin 138 to allow rack 152 to be attached to either side of carrier component 154. Similarly, thumbturn link 134 comprises a second slot 136, 180 degrees from first slot 136. This enables thumbturn link 134 to be used in either a right or left-handed application similar to thumbturn link 34 shown in the previous embodiment.

The operation of interconnected lock 10 is best described in a dynamic manner starting with carrier component 54 position in a lowered, or locked position. Movement of carrier component 54 from a locked position to an unlocked position can be accomplished by either rotating inside knob/lever 26, rotating thumbturn 32, or by turning a key to rotate the rotating driver bar 60 of deadbolt assembly 42, typically with a key. Movement of carrier component 54 and attached rack 52 causes rotation of pinion 50 and driver bar 60, retracting deadbolt 90 of deadbolt latch assembly 44. At the end of the carrier component 54 travel, the deadbolt latch assembly 44 is fully retracted.

Although the present invention has been described above in detail, the same is by way of illustration and example only and is not to be taken as a limitation on the present invention. Accordingly, the scope and content of the present invention are to be defined only by the terms of the appended claims.

What is claimed is:

1. An interconnected lock assembly for mounting in a door, comprising:
a first lock assembly,
a second lock assembly interconnected to said first lock assembly by a rack mounted on a carrier component, wherein said second lock assembly is operably connected to a deadbolt latch assembly, said deadbolt latch assembly comprising a deadbolt movable between an extended position when said carrier component is in a lowered position and a retracted position when said carrier component is in a raised position;
a thumbturn attached to a thumbturn link component, wherein said thumbturn link pivotally connects said thumbturn to said rack such that said thumbturn is operably interconnected to said first lock assembly and said second lock assembly.

2. The interconnected lock assembly of claim 1, wherein said thumbturn link comprises at least one pin.

3. The interconnected lock assembly of claim 2, wherein said at least one pin engages a corresponding slot in said rack, pivotally engaging said thumbturn to said rack such that rotation of said thumbturn results in vertical movement of said rack.

4. The interconnected lock assembly of claim 2, wherein said at least one pin engages a corresponding slot in said rack, pivotally engaging said thumbturn to said rack such that vertical movement of said rack results in rotation of said thumbturn.

5. The interconnected lock assembly of claim 1, wherein said thumbturn link comprises at least one slot.

6. The interconnected lock assembly of claim 5, wherein said at least one slot engages a corresponding pin of said rack, pivotally engaging said thumbturn to said rack such that rotation of said thumbturn results in vertical movement of said rack.

7. The interconnected lock assembly of claim 5, wherein said at least one slot engages a corresponding pin of said rack, pivotally engaging said thumbturn to said rack such that vertical movement of said rack results in rotation of said thumbturn.

8. The interconnected lock assembly of claim 1, wherein said thumbturn link comprises at least two pins oriented on opposite sides of said thumbturn link.

9. The interconnected lock assembly of claim 1, wherein said thumbturn link comprises at least two slots oriented on opposite sides of said thumbturn link.

10. A thumbturn for an interconnected lock assembly mounted in the door, comprising:
an interconnected lock assembly comprising a first lock assembly and a second lock assembly, interconnected by a rack mounted on a carrier component, wherein said second lock assembly is operably connected to a deadbolt latch assembly, said deadbolt latch assembly comprising a deadbolt movable between an extended position when said carrier component is in a lowered position and a retracted position when said carrier component is in a raised position;
a thumbturn knob;
a thumbturn link component coupled to said thumbturn knob and pivotally connected to said rack such that vertical movement of said rack results in rotational movement of said thumbturn knob and rotational movement of said thumbturn knob results in vertical movement of said rack.

11. The thumbturn of claim 10, wherein said thumbturn link comprises at least one pin.

12. The thumbturn of claim 11, wherein said at least one pin engages a corresponding slot in said rack, pivotally engaging said thumbturn to said rack.

13. The thumbturn of claim 10, wherein said thumbturn link comprises at least one slot.

14. The thumbturn of claim 13, wherein said at least one slot engages a corresponding pin of said rack, pivotally engaging said thumbturn to said rack.

15. The thumbturn of claim 10, wherein said thumbturn link comprises at least two pins oriented on opposite sides of said thumbturn link.

16. The thumbturn of claim 10, wherein said thumbturn link comprises at least two slots oriented on opposite sides of said thumbturn link.
